(19) United States
(12) Patent Application Publication
(10) Pub. No.: US 2026/0118804 A1
(43) Pub. Date: Apr. 30, 2026

(54) SLIDING MEMBER, FIXING DEVICE, AND IMAGE FORMING APPARATUS

(71) Applicant: FUJIFILM Business Innovation Corp., Tokyo (JP)

(72) Inventors: Hideaki Ohara, Kanagawa (JP); Ryohei Yoshikawa, Kanagawa (JP); Taiki Nagamatsu, Kanagawa (JP); Tomotake Inagaki, Kanagawa (JP); Hitoshi Komuro, Kanagawa (JP)

(73) Assignee: FUJIFILM Business Innovation Corp., Tokyo (JP)

(21) Appl. No.: 19/306,073

(22) Filed: Aug. 21, 2025

(30) Foreign Application Priority Data
Oct. 31, 2024 (JP) 2024-192255

(51) Int. Cl. G03G 15/20

(52) U.S. Cl. CPC G03G 15/206; G03G 15/2025; G03G 15/2064; G03G 2215/2025

(57) ABSTRACT

A sliding member has a sliding surface on which a sliding object slides, in which the sliding surface has formed thereon a plurality of first grooves, a plurality of second grooves, and a plurality of third grooves, in which the first grooves extend in a sliding direction of the sliding object and are arranged in the sliding direction at intervals in a plurality of rows, in which the plurality of rows are arranged in an orthogonal direction orthogonal to the sliding direction at intervals, in which, in two adjacent rows of the plurality of rows that are adjacent to each other in the orthogonal direction, the first grooves in one of the two adjacent rows are staggered from the first grooves in the other one of the two adjacent rows in the sliding direction, in which the second grooves extend in a direction different from the direction in which the first grooves extend, in which the second grooves connect, to each other, adjacent ones of the plurality of first grooves that are adjacent to each other in the orthogonal direction and connect, to each other, adjacent ones of the plurality of first grooves that are diagonally adjacent to each other and displaced from each other in the sliding direction, in which each of the third grooves extends in the sliding direction and connects corresponding two adjacent ones of the plurality of first grooves that are adjacent to each other in the sliding direction, and in which at least part of each of the third grooves has a smaller cross-sectional area than each of the first grooves.

### CROSS-REFERENCE TO RELATED APPLICATIONS

This application is based on and claims priority under 35 USC 119 from Japanese Patent Application No. 2024-192255 filed Oct. 31, 2024.

### BACKGROUND

The present disclosure relates to a sliding member, a fixing device, and an image forming apparatus.

### (ii) RELATED ART

For example, Japanese Unexamined Patent Application Publication No. 2017-181948 discloses a sliding member that has a sliding surface in contact with the inner circumferential surface of a belt and is disposed so as to face a pressure member with the belt interposed between the sliding member and the pressure member. A direction in which the rotating belt slides on the sliding surface during transfer of a recording medium is referred to as a transfer direction. A plurality of first grooves extending in a direction intersecting the transfer direction are formed on the sliding surface, and a plurality of second grooves are formed on the sliding surface and each provide communication between corresponding adjacent two of the plurality of first grooves. The first grooves and the second grooves are formed in a non-lattice pattern.

### SUMMARY

Aspects of non-limiting embodiments of the present disclosure relate to a sliding member in which an increase in sliding resistance between the sliding member and a sliding object that slides on the sliding surface of the sliding member is smaller than that when grooves with a constant cross-sectional area extend in the sliding direction on the sliding surface on which the sliding object slides and also relate to a fixing device and an image forming apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a sliding member having a sliding surface on which a sliding object slides, wherein the sliding surface has formed thereon a plurality of first grooves, a plurality of second grooves, and a plurality of third grooves, wherein the first grooves extend in a sliding direction of the sliding object and are arranged in the sliding direction at intervals in a plurality of rows, wherein the plurality of rows are arranged in an orthogonal direction orthogonal to the sliding direction at intervals, wherein, in two adjacent rows of the plurality of rows that are adjacent to each other in the orthogonal direction, the first grooves in one of the two adjacent rows are staggered from the first grooves in the other one of the two adjacent rows in the sliding direction, wherein the second grooves extend in a direction different from the direction in which the first grooves extend, wherein the second grooves connect, to each other, adjacent ones of the plurality of first grooves that are adjacent to each other in the orthogonal direction and connect, to each other, adjacent ones of the plurality of first grooves that are diagonally adjacent to each other and displaced from each other in the sliding direction, wherein each of the third grooves extends in the sliding direction and connects corresponding two adjacent ones of the plurality of first grooves that are adjacent to each other in the sliding direction, and wherein at least part of each of the third grooves has a smaller cross-sectional area than each of the first grooves.

### BRIEF DESCRIPTION OF THE DRAWINGS

Exemplary embodiments of the present disclosure will be described in detail based on the following figures, wherein:

FIG. 1 is a schematic illustration showing an example of an image forming apparatus according to a first exemplary embodiment;

FIG. 2 is a schematic illustration showing an example of a fixing device according to the first exemplary embodiment;

FIG. 3 is a schematic plan view showing a sliding sheet according to the first exemplary embodiment;

FIG. 4 is an enlarged illustration of the sliding sheet according to the first exemplary embodiment;

FIG. 5 is a cross-sectional view viewed from a direction V in FIG. 4 and showing the shapes of first and third grooves in the sliding sheet according to the first exemplary embodiment;

FIG. 6 is a cross-sectional view viewed from a direction VI in FIG. 4 and showing the shapes of second grooves in the sliding sheet according to the first exemplary embodiment;

FIG. 7 is a schematic plan view showing a sliding sheet according to a second exemplary embodiment; and

FIG. 8 is a schematic plan view showing a sliding sheet according to a third exemplary embodiment.

### DETAILED DESCRIPTION

Exemplary embodiments of the present disclosure will be described below. The following description and Examples are illustrative of the exemplary embodiments and are not intended to limit the scope of the present disclosure. In a set of numerical ranges expressed in a stepwise manner in the present specification, the upper or lower limit in one numerical range may be replaced with the upper or lower limit in another numerical range in the set of numerical ranges. Moreover, in a numerical range described in the present specification, the upper or lower limit in the numerical range may be replaced with a value indicated in an Example.

Any component may contain a plurality of materials corresponding to the component. When reference is made to the amount of a component, if a plurality of materials corresponding to the component are present, the amount means the total amount of the plurality of materials, unless otherwise specified.

### First Exemplary Embodiment

### (Structure)

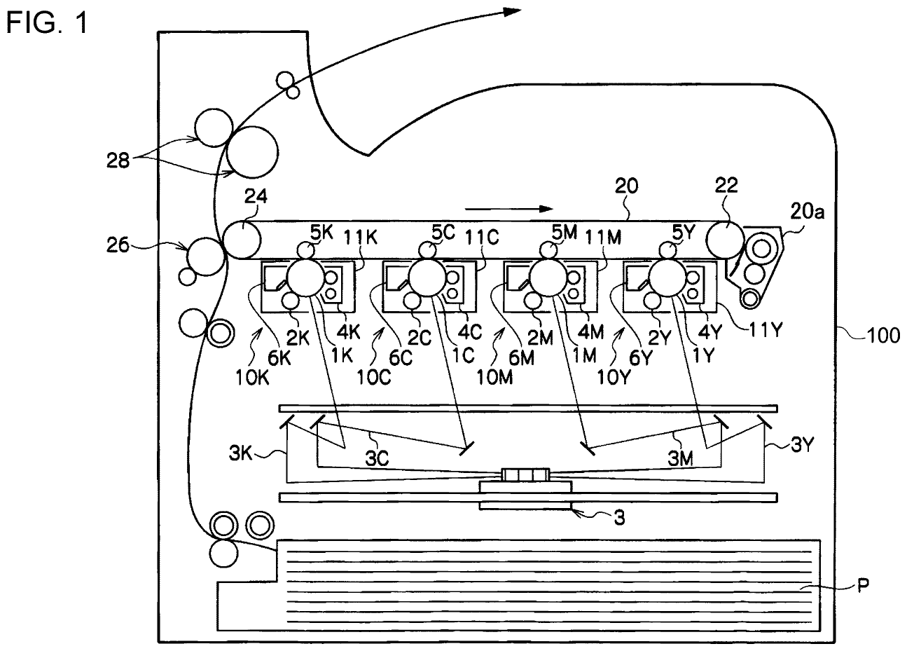

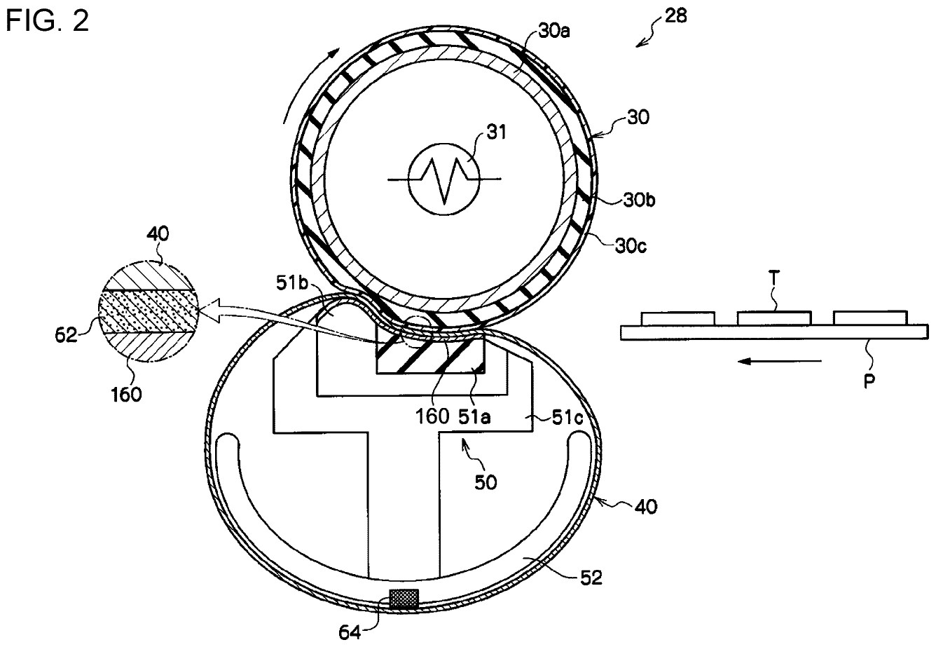

FIG. 1 is a schematic illustration showing an image forming apparatus 100 according to the present exemplary embodiment. FIG. 2 is a schematic illustration showing an example of the fixing device according to the exemplary embodiment. FIG. 2 is a schematic illustration showing a fixing device 28 according to the present exemplary embodiment.

As shown in FIG. 1, the image forming apparatus 100 according to the present exemplary embodiment includes first to fourth electrophotographic process cartridges 10Y, 10M, 10C, and 10K that output yellow (Y), magenta (M), cyan (C), and black (K) images, respectively, based on color-separated image data. These process cartridges 10Y, 10M, 10C, and 10K are arranged so as to be spaced apart from each other along the outer circumferential surface of an intermediate transfer belt 20. These process cartridges 10Y, 10M, 10C, and 10K are detachably attached to the image forming apparatus 100.

The intermediate transfer belt 20 serving as an intermediate transfer body is disposed above (in FIG. 1) the process cartridges 10Y, 10M, 10C, and 10K such that the outer circumferential surface of the intermediate transfer belt 20 faces the process cartridges. The intermediate transfer belt 20 is wound around a driving roller 22 and a support roller 24 that are disposed so as to be spaced apart from each other, the support roller 24 being in contact with the inner circumferential surface of the intermediate transfer belt 20. The intermediate transfer belt 20 is tensioned between these rollers and runs endlessly in a direction from the first process cartridge 10Y toward the fourth process cartridge 10K.

The support roller 24 is pressed by an unillustrated elastic member such as a spring in a direction away from the driving roller 22, and a tension is thereby applied to the intermediate transfer belt 20 wound between these rollers. An intermediate transfer body cleaning device 20a is disposed on the outer circumferential surface of the intermediate transfer belt 20 so as to be opposed to the driving roller 22.

Since the first process cartridge 10Y to the fourth process cartridge 10K have substantially the same structure, the first process cartridge 10Y that is disposed on an upstream side in the running direction of the intermediate transfer belt and forms a yellow image will be described as a representative. The same portions of the second process cartridge 10M to the fourth process cartridge 10K as those in the first process cartridge 10Y are designated by the same reference symbols with the letter yellow (Y) replaced with magenta (M), cyan (C), and black (K), respectively, and their description will be omitted.

The first process cartridge 10Y includes a photoconductor 1Y serving as an image holding member. A charging roller 2Y that charges the surface of the photoconductor 1Y to a prescribed potential, a developing device 4Y that supplies a charged toner contained in a developer to an electrostatic latent image to develop the electrostatic latent image, and a photoconductor cleaning device 6Y that removes the toner remaining on the surface of the photoconductor 1Y after first transfer are sequentially disposed around the photoconductor 1Y. These are disposed integrally in a housing 11Y (casing). In the second process cartridge 10M to the fourth process cartridge 10K also, their components are disposed integrally in the respective housings 11M to 11K (casings).

A first transfer roller 5Y that transfers the developed toner image onto the intermediate transfer belt 20 and an exposure device 3 that irradiates the charged surface with a laser beam 3Y according to a color-separated image signal to form an electrostatic latent image are disposed together with the first process cartridge 10Y to thereby form an image forming unit. The charging roller 2Y and the exposure device 3 correspond to an example of the latent image forming device in the present disclosure.

The first transfer roller 5Y is disposed on the inner side of the intermediate transfer belt 20 and located at a position opposed to the photoconductor 1Y. Unillustrated bias power sources that apply first transfer biases are connected to the first transfer rollers 5Y, 5M, 5C, and 5K. Each bias power source is controlled by an unillustrated controller and changes the transfer bias applied to the corresponding first transfer roller.

### (Fixing Device)

As shown in FIG. 2, the fixing device 28 includes a heating roller 30 and a pressing belt 40, and the heating roller 30 and the pressing belt 40 are disposed so as to be opposed to each other. The pressing belt 40 is pressed against the heating roller 30 by a pressing pad 50 disposed on the inner circumferential side of the pressing belt 40 and is driven by a driving force from the heating roller 30 and guided along a belt running guide 52 while a contact portion is formed between the pressing belt 40 and the heating roller 30 that are in pressure contact with each other. The heating roller 30 is an example of the first rotatable member in the present disclosure. The pressing belt 40 is an example of the second rotatable member in the present disclosure and is also an example of the sliding object. The pressing pad 50 is an example of the pressing member according to the present exemplary embodiment.

A sliding sheet 160 is interposed between the pressing belt 40 and the pressing pad 50. A lubricant 62 is interposed between the sliding sheet 160 and the inner circumferential surface of the pressing belt 40. The lubricant 62 is supplied to the inner circumferential surface of the pressing belt 40 from, for example, a lubricant supply member 64 disposed in a part of the belt running guide 52 so as to be interposed between the sliding sheet 160 and the inner circumferential surface of the pressing belt 40. In FIG. 2, T represents a toner image.

The heating roller 30 includes a hollow metal core 30a including a heat source 31 such as a halogen lamp disposed thereinside and further includes an elastic layer 30b and a release layer 30c that are formed in this order on the metal core 30a.

The metal core 30a is formed from a cylindrical body made of a metal such as aluminum or stainless steel. The elastic layer 30b is made of, for example, an HTV silicone rubber or a fluorocarbon rubber (Their JIS-A rubber hardness is about 45 degrees. The rubber hardness is measured using an A-type hardness meter of the spring type manufactured by Teclock Corporation under a load of 1,000 gf according to JIS K6301) and has a thickness of about 2 mm or more and about 5 mm or less. The release layer 30c is made of, for example, a fluorocarbon rubber, a silicone rubber, or a fluorocarbon resin and has a thickness of 20 μm or more and 50 μm or less. The material of the release layer 30c is not limited to these materials, and well-known materials may be used.

The heating roller 30 serves as a fixing roller and is driven to rotate such that its peripheral speed is adjusted to, for example, 260 mm/sec by an unillustrated driving source. The outer diameter of the heating roller 30 is generally, for example, about 25 mm or more and about 80 mm or less.

The surface temperature of the heating roller 30 is detected by an unillustrated temperature sensor in contact with its surface and controlled to, for example, 175° C. by an unillustrated control circuit.

The pressing belt 40 is formed such that its inner circumferential surface contains, for example, a polyimide resin, a polyamide-imide resin, a polyether ether ketone resin, a polyphenylene sulfide resin, a polyethersulfone resin, a polysulfone resin, a polyphenylsulfone resin, etc.

The sliding sheet 160 according to the present exemplary embodiment may be formed such that its sliding surface SS contains a heat resistant thermoplastic resin. Specifically, the sliding sheet 160 according to the present exemplary embodiment is formed as a single layer body composed of a resin base layer containing a heat resistant thermoplastic resin. However, the sliding sheet 160 may be a layered body including the resin base layer and an additional layer disposed on the side opposite from the sliding surface of the resin base layer.

Examples of the heat resistant thermoplastic resin include polyimide resins, polyether ether ketone resins, polyphenylene sulfide resins, polyetherimide resins, polyphenylsulfone resins, polyethersulfone resins, polysulfone resins, polyamide resins, and fluorocarbon resins.

In particular, the heat resistant thermoplastic resin is preferably at least one resin selected from the group consisting of polyether ether ketone resins, polyphenylene sulfide resins, polyetherimide resins, and polyphenylsulfone resins and more preferably at least one resin selected from the group consisting of polyether ether ketone resins and polyphenylene sulfide resins. These resins (in particular, polyether ether ketone resins and polyphenylene sulfide resins) may be used because of their high wear resistance, high toughness, and a high elastic modulus.

The resin base layer forming the sliding surface may contain well-known additives such as carbon fibers, carbon nanotubes, or resin particles having siloxane groups (such as thermosetting silicone resin particles, silicone oil gum particles, silicone elastomer particles, and siloxane-modified polyetherimide particles) for the purpose of reducing the sliding resistance of the sliding surface. The resin base layer forming the sliding surface may contain additional components such as a conducting agent, a filler for improving mechanical strength, an antioxidant for preventing thermal deterioration, a surfactant, and a heat resistant antioxidant.

Examples of the lubricant 62 include fluorinated oil, silicone oil, and synthetic lubricating grease prepared by mixing a solid material and a liquid. Examples of the fluorinated oil include perfluoropolyether oil and modified perfluoropolyether oil. Examples of the silicone oil include dimethyl silicone oil, organic metal salt-added dimethyl silicone oil, hindered amine-added dimethyl silicone oil, organic metal salt and hindered amine-added dimethyl silicone oil, methylphenyl silicone oil, amino-modified silicone oil, organic metal salt-added amino-modified silicone oil, hindered amine-added amino-modified silicone oil, carboxy-modified silicone oil, silanol-modified silicone oil, and sulfonic acid-modified silicone oil. Examples of the synthetic lubricating grease include silicone grease (i.e., grease containing the silicone oil described above) and fluorinated grease (i.e., grease containing the fluorinated oil described above).

The lubricant 62 may contain, in addition to the oil, additional components. Examples of the additional components include a heat transfer agent, an antioxidant, a surfactant, silicone particles, an organic metal salt, and a hindered amine.

The resin base layer may contain additional components in addition to the resin. Examples of the additional components include a conducting agent, a filler for improving mechanical strength, an antioxidant for preventing thermal deterioration, a surfactant, and a heat resistant antioxidant.

In the above example, the first rotatable member is the heating roller 30, and the second rotatable member is the pressing belt 40. However, in another embodiment, the first rotatable member may be a pressing roller, and the second rotatable member may be a heating belt. When the first rotatable member is a pressing roller, the structure of the pressing roller may be the same as the structure of the heating roller 30 described above. When the second rotatable member is a heating belt, the structure of the heating belt may be the same as the structure of the pressing belt 40 described above. In particular, when the second rotatable member is a heating belt, the heating belt may be a single layer body composed of a resin base layer forming the inner circumferential surface of the heating belt, a layered body including the resin base layer forming the inner circumferential surface of the heating belt, an elastic layer disposed on the resin base layer, and a release layer disposed on the clastic layer, a layered body including the resin base layer forming the inner circumferential surface of the heating belt and a release layer disposed on the resin base layer, or a layered body including the resin base layer forming the inner circumferential surface of the heating belt, a metal layer disposed on the resin base layer, an elastic layer disposed on the metal base layer, and a release layer disposed on the elastic layer.

The elastic layer contains a heat resistant elastic material. Examples of the heat resistant elastic material include silicone rubber and fluorocarbon rubber. Examples of the silicone rubber include RTV (Room Temperature Vulcanizing) silicone rubber, HTV (High Temperature Vulcanizing) silicone rubber, and liquid silicone rubber. Specific examples include polydimethyl silicone rubber, methylvinyl silicone rubber, methylphenyl silicone rubber, and fluorosilicone rubber. Examples of the fluorocarbon rubber include vinylidene fluoride-based rubber, tetrafluoroethylene/propylene-based rubber, tetrafluoroethylene/perfluoromethyl vinyl ether rubber, phosphazene-based rubber, and fluoropolyether.

The clastic layer may contain additional components. Examples of the additional components include a filler, a conducting agent, a softener (such as a paraffin-based softener), a processing aid (such as stearic acid), an antioxidant (such as an amine-based antioxidant), a vulcanizing agent (sulfur, a metal oxide, a peroxide, etc.), and a functional filler (such as alumina).

The release layer contains, for example, a heat resistant release material. Examples of the heat resistant release material include fluorocarbon rubber, fluorocarbon resins, silicone resins, and polyimide resins. In particular, the heat resistant release material may be a fluorocarbon resin. Specific examples of the fluorocarbon resin include: polytetrafluoroethylene (PTFE); and tetrafluoroethylene-perfluoroalkyl vinyl ether copolymers (PFA) such as tetrafluorocthylene-perfluoromethyl vinyl ether copolymers (MFA), tetrafluoroethylene-perfluoroethyl vinyl ether copolymers (EFA), and tetrafluoroethylene-perfluoropropyl vinyl ether copolymers. Other examples include tetrafluoroethylene-hexafluoropropylene copolymers (FEP), ethylene-tetrafluoroethylene copolymers (ETFE), polyvinylidene fluoride (PVDF), polychlorotrifluoroethylene (PCTFE), and polyvinyl fluoride (PVF). Of these, polytetrafluoroethylene (PTFE) and tetrafluoroethylene-perfluoroalkyl vinyl ether copolymers (PFA) such as tetrafluoroethylene-perfluoromethyl vinyl ether copolymers (MFA) and tetrafluoroethylene-perfluorocthyl vinyl ether copolymers (EFA) may be used in terms of heat resistance, mechanical properties, etc. The thickness of the release layer is set to preferably 5 μm to 100 μm and more preferably 10 μm to 30 μm.

The pressing pad 50 includes two pressing members 51a and 51b having different hardnesses and arranged in the traveling direction of a recording medium P. The pressing member 51a on the recording medium P insertion side of the pressing pad 50 is formed from a rubber-like elastic member, and the pressing member 51b on the recording medium P discharge side is formed from a hard pressure-applying member such as a metal, so that the pressure in the contact region is higher on the recording medium P discharge side than on the recording medium P insertion side. The pressing members 51a and 51b are supported by a holder 51c, press the inner circumferential surface of the pressing belt 40 via the sliding sheet 160, and thus press the heating roller 30.

The sliding sheet 160 is an example of the sliding member according to the present exemplary embodiment. A specific structure of the sliding sheet 160 will next be described.

### (Sliding Sheet)

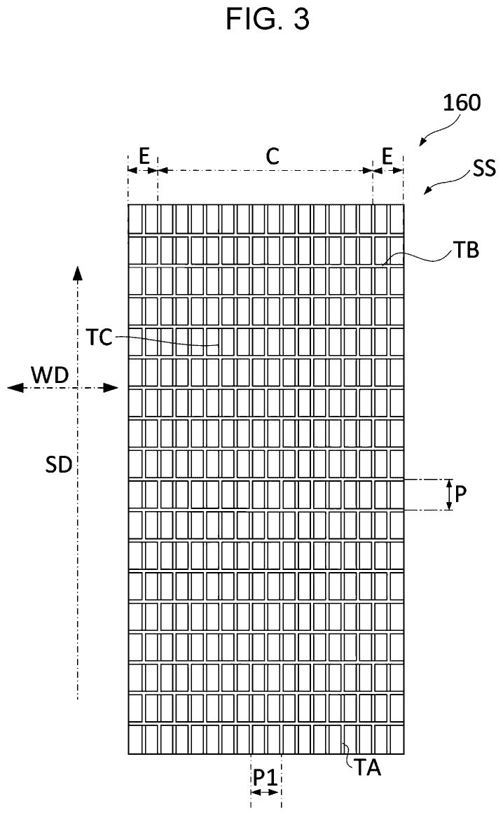

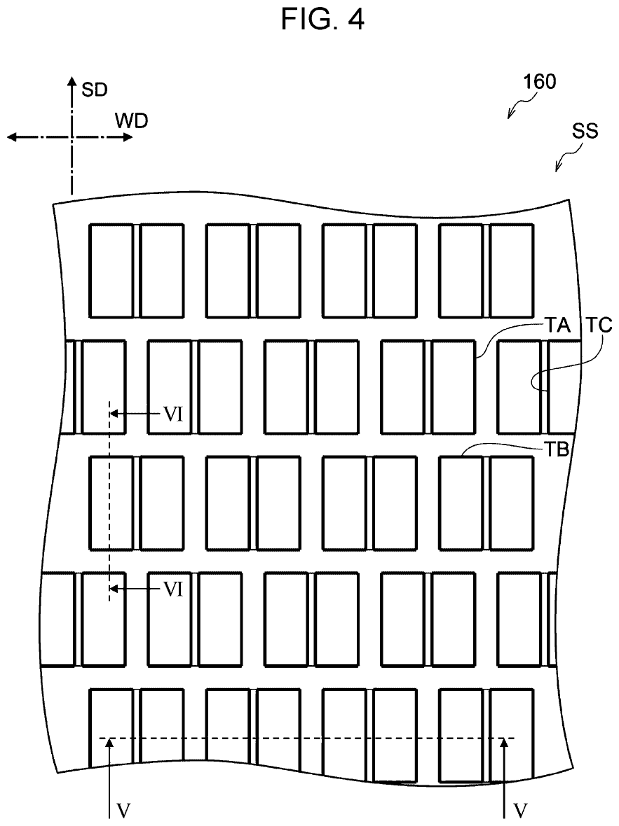

As shown in FIG. 3 and FIG. 4, which is an enlarged illustration of FIG. 3, in the sliding sheet 160 according to the present exemplary embodiment, a plurality of first grooves TA, a plurality of second grooves TB, and a plurality of third grooves TC are formed on the sliding surface SS. In FIG. 3 and subsequent figures, an arrow SD represents a sliding direction, and an arrow WD represents the width direction of the sliding sheet 160. The width direction WD of the sliding sheet 160 is an example of the orthogonal direction in the present disclosure. In FIG. 3, C represents a central portion, with respect to the width direction, of the sliding surface SS. In FIG. 3, E represents edge portions, with respect to the width direction, of the sliding surface SS.

As shown in FIGS. 3 and 4, the first grooves TA are grooves extending in the sliding direction SD. More specifically, the first grooves TA are arranged in the sliding direction SD at intervals in a plurality of rows, and the plurality of rows are arranged in the width direction WD at intervals. In two rows adjacent to each other in the width direction WD, the first grooves TA in one of the two rows are staggered from the first grooves TA in the other row in the sliding direction SD.

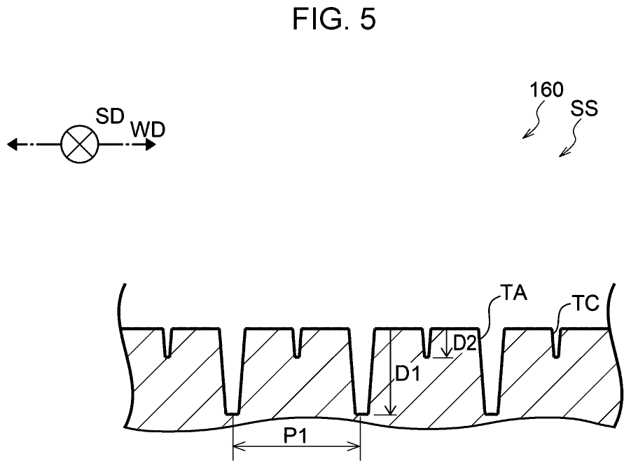

As shown in FIG. 5, in the present exemplary embodiment, the specific shape of the first grooves TA can be set as follows. When a cross section obtained by cutting the sliding sheet 160 in the thickness direction and a direction perpendicular to the first grooves TA is observed, the depth of the first grooves TA is preferably 15 μm or more and 45 μm or less and more preferably 20 μm or more and 40 μm or less. When the cross section obtained by cutting the sliding sheet 160 in the thickness direction and the direction perpendicular to the first grooves TA is observed, the width of the first grooves TA is preferably 50 μm or more and 190 μm or less, more preferably 60 μm or more and 180 μm or less, and still more preferably 70 μm or more and 160 μm or less.

When the cross section obtained by cutting the sliding sheet 160 in the thickness direction and the direction perpendicular to the first grooves TA is observed, the pitch PI of the first grooves TA (i.e., the distance between the first grooves TA) is preferably 200 μm or more and 900 μm or less, more preferably 300 μm or more and 700 μm or less, and still more preferably 400 μm or more and 500 μm or less.

As shown in FIGS. 3 and 4, the second grooves TB are grooves extending in the width direction WD. More specifically, the second grooves TB connect, to each other, adjacent first grooves TA adjacent to each other in the width direction WD and connect, to each other, adjacent first grooves TA that are diagonally adjacent to each other and displaced from each other in the sliding direction SD. Therefore, the first grooves TA and the second grooves TB form rectangular grooves on the sliding surface SS.

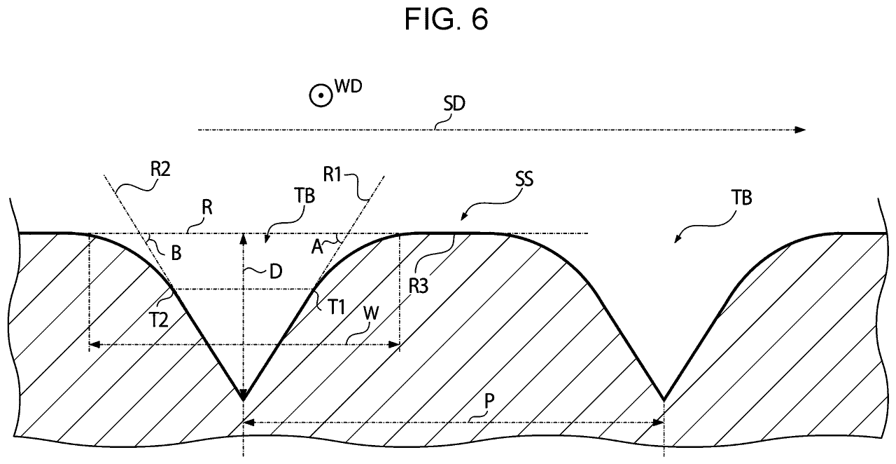

As shown in FIG. 6, in the present exemplary embodiment, the specific shape of the second grooves TB is set as follows. When a cross section obtained by cutting the sliding sheet 160 in the thickness direction and a direction perpendicular to the second grooves TB is observed, the angle A between the sliding direction SD and a wall surface of each second groove TB that is located on the downstream side in the sliding direction SD is 21° or more and 45° or less. The angle A is preferably 23° or more and 40° or less and more preferably 25° or more and 30° or less. If the angle A is less than 21°, the lubricant 62 residing in the second grooves TB is not easily supplied to a contact portion between the sliding surface SS and the surface of the sliding object, and therefore the sliding resistance tends to increase. If the angle A is larger than 45°, the coefficient of friction between the sliding surface SS and the surface of the sliding object is large, and therefore the sliding resistance tends to increase.

When the cross section obtained by cutting the sliding sheet 160 in the thickness direction and the direction perpendicular to the second grooves TB is observed, the angle B between the sliding direction SD and a wall surface of each second groove TB that is located on the upstream side in the sliding direction SD is preferably 10° or more and 35° or less, more preferably 15° or more and 30° or less, and still more preferably 12° or more and 25° or less. When the angle B is 35° or less, the lubricant 62 residing in the second grooves TB is easily supplied to the contact portion between the sliding surface SS and the surface of the sliding object. In this case, the sliding resistance of the sliding sheet 160 is low, and the ability to maintain the low sliding resistance tends to be improved.

Like the first grooves TA, the third grooves TC are grooves extending in the sliding direction SD, as shown in FIGS. 3 and 4. More specifically, the third grooves TC are grooves that connect the first grooves TA arranged in the sliding direction SD. In other words, the first grooves TA and the third grooves TC are formed so as to be alternately arranged.

As shown in FIG. 5, the shape of the first grooves TA differs from the shape of the third grooves TC. More specifically, the cross-sectional area of each third groove TC is smaller than the cross-sectional area of each first groove TA. In the present exemplary embodiment, the specific shape of the third grooves TC can be set as follows. The cross section obtained by cutting the sliding sheet 160 in the thickness direction and the direction perpendicular to the first grooves TA is observed. The depth of the first grooves TA is denoted as D1, and the depth of the third grooves TC is denoted as D2. Then D2/D1 is preferably 0.02 or more and 0.35 or less and more preferably 0.07 or more and 0.20 or less.

In the present exemplary embodiment, at least some of the first grooves TA, at least some of the second grooves TB, and at least some of the third grooves TC are disposed in a widthwise central portion of the sliding sheet 160. The widthwise central portion of the sliding surface SS is defined as follows. Regions extending from opposite edges, with respect to the width direction WD, of the sliding sheet 160 toward the center and having a length of 18% of the width of the sliding surface SS are defined as opposite widthwise edge portions of the sliding surface SS. Then a region sandwiched between the opposite edge portions is defined as the widthwise central portion.

The angle A, the angle B, the depth of the second grooves TB, the width of the second grooves TB, and the pitch P of the second grooves TB are shown in FIGS. 4 and 6 and defined as follows.

The angle A is the angle between the sliding direction SD and a tangent line tangent to a wall surface of a second groove TB on the downstream side in the sliding direction SD at a position ⅓ of the depth of the second groove TB (specifically the angle A is an acute angle). The angle B is the angle between the sliding direction SD and a tangent line tangent to a wall surface of the second groove TB on the upstream side in the sliding direction SD at a position ⅓ of the depth of the second groove TB (specifically the angle B is an acute angle). The depth of each second groove TB is the length from a reference line corresponding to the sliding surface SS between adjacent second grooves TB to the deepest bottom point of the second groove TB. The reference line is a line at the arithmetic mean of ten measurements of the thickness of the sliding sheet 160 at the center between the adjacent second grooves TB on the sliding surface SS. The width of each second groove TB is the length between edges of the groove that intersect the reference line corresponding to the sliding surface SS between adjacent second grooves TB. The pitch P of the second grooves TB is the length between the deepest bottom points of second grooves TB adjacent to each other.

The angle A, the angle B, the depth of the second grooves TB, the width of the second grooves TB, and the pitch P of the second grooves TB are respective arithmetic mean values of ten measurements.

In FIG. 6, D is the depth of a second groove TB, and W is the width of the second groove TB. P is the pitch P of the second grooves TB. T1 is the wall surface of the second groove TB on the downstream side in the sliding direction SD at a position ⅓ of the depth of the second groove TB, and R1 is the tangent line tangent to the wall surface of the second groove TB on the downstream side in the sliding direction SD at the position ⅓ of the depth of the second groove TB. T2 is the wall surface of the second groove TB on the upstream side in the sliding direction SD at a position ⅓ of the depth of the second groove TB, and R2 is the tangent line tangent to the wall surface of the second groove TB on the upstream side in the sliding direction SD at the position ⅓ of the depth of the second groove TB. R3 is the center between the adjacent second grooves TB on the sliding surface SS, and R is the reference line corresponding to the sliding surface SS between the adjacent second grooves TB.

The cross-sectional area of each first groove TA and the cross-sectional area of each third groove TC may gradually decrease from the upstream side in the sliding direction SD toward the downstream side in the sliding direction SD. When at least one of the cross-sectional area of each first groove TA and the cross-sectional area of each third groove TC decreases gradually, the lubricant 62 can easily exude from the grooves. Therefore, the sliding resistance between the sliding surface SS and the inner circumferential surface of the pressing belt 40 tends to be low, and the low sliding resistance can be easily maintained.

The “cross-sectional area of a groove” is its cross-sectional area when the sliding sheet 160 is cut in the thickness direction and a direction perpendicular to the lengthwise direction of the groove. The phrase “the cross-sectional area of a groove gradually decreases form the upstream side in the sliding direction toward the downstream side in the sliding direction” means that the cross-sectional area of the groove on the downstream side in the sliding direction SD is smaller than the cross-sectional area of the groove on the upstream side in the sliding direction SD.

Specifically, the cross-sectional area of each groove at its end on the upstream side in the sliding direction SD may be 700 μm² or more and 4300 μm² or less. The depth of each groove at its end on the upstream side in the sliding direction SD may be 20 μm or more and 45 μm or less. The cross-sectional area of each groove at its end on the downstream side in the sliding direction SD may be 175 μm² or more and 1430 μm² or less. The depth of each groove at its end on the downstream side in the sliding direction SD may be 5 μm or more and 45 μm or less.

To adjust the cross-sectional area of each groove, the depth of the groove may be adjusted. For a groove that is not located at the upstream or downstream edge of the sliding surface SS in the sliding direction SD, the cross-sectional area and depth of the groove at its upstream or downstream end in the sliding direction SD are the cross-sectional area and depth of the portion of the groove closest to the upstream or downstream edge of the sliding surface SS in the sliding direction SD.

No particular limitation is imposed on the method for forming the grooves on the sliding surface SS. A well-known method such as press forming is used.

### (Image Forming Operations of Image Forming Apparatus 100)

Next, the image forming operations of the image forming apparatus 100 according to the present exemplary embodiment will be described. The operation for forming a yellow image in the first process cartridge 10Y will be described as a representative image forming operation.

First, before the image forming operation, the charging roller 2Y charges the surface of the photoconductor 1Y to a potential of, for example, about −600 V or more to about −800 V or less.

The photoconductor 1Y is formed, for example, by stacking a photosensitive layer on an electrically conductive base. The resistance of the photosensitive layer is generally high. One property of the photosensitive layer is that, when the photosensitive layer is irradiated with the laser beam 3Y, the specific resistance of the portion irradiated with the laser beam is changed. Therefore, the laser beam 3Y is outputted through the exposure device 3 onto the charged surface of the photoconductor 1Y according to yellow image data sent from an unillustrated controller. The photosensitive layer on the surface of the photoconductor 1Y is irradiated with the laser beam 3Y, and an electrostatic latent image having a yellow print pattern is thereby formed on the surface of the photoconductor 1Y.

As the photoconductor 1Y runs, the electrostatic latent image formed on the photoconductor 1Y as described above is rotated to a developing position. The electrostatic latent image on the photoconductor 1Y is visualized at the developing position by the developing device 4Y (a toner image is formed).

The developing device 4Y houses a developer containing, for example, a yellow toner and a carrier. The yellow toner is agitated within the developing device 4Y and thereby frictionally charged. The charged yellow toner has a charge with the same polarity (negative polarity) as the charge on the photoconductor 1Y. As the surface of the photoconductor 1Y passes through the developing device 4Y, the yellow toner electrostatically adheres only to charge-eliminated latent image portions on the surface of the photoconductor 1Y, and the latent image is thereby developed with the yellow toner. Then the photoconductor 1Y with the yellow toner image formed thereon continues running, and the toner image developed on the photoconductor 1Y is transported to a first transfer position.

When the yellow toner image on the photoconductor 1Y is transported to the first transfer position, a first transfer bias is applied to the first transfer roller 5Y, and an electrostatic force directed from the photoconductor 1Y toward the first transfer roller 5Y acts on the toner image, so that the toner image on the photoconductor 1Y is transferred onto the intermediate transfer belt 20. The transfer bias applied in this case has a (+) polarity opposite to the (−) polarity of the toner and is controlled to, for example, about +10 μA in the first process cartridge 10Y by the controller (not shown).

The first transfer biases applied to the first transfer rollers 5M, 5C, and 5K of the second process cartridge 10M and subsequent process cartridges are controlled in the same manner as that for the first process cartridge.

The intermediate transfer belt 20 with the yellow toner image transferred thereon in the first process cartridge 10Y is sequentially transported through the second to fourth process cartridges 10M, 10C, and 10K, and toner images of respective colors are superimposed and multi-transferred.

Then the intermediate transfer belt 20 with all the color toner images multi-transferred thereon in the first to fourth process cartridges reaches a second transfer portion that is composed of the intermediate transfer belt 20, the support roller 24 in contact with the inner circumferential surface of the intermediate transfer belt 20, and a second transfer roller 26 disposed on the image holding surface side of the intermediate transfer belt 20. A recording medium P is supplied to a gap between the secondary transfer roller 26 and the intermediate transfer belt 20 through a supply mechanism, and a second transfer bias is applied to the support roller 24. The transfer bias applied in this case has the same polarity (−) as the polarity (−) of the toner, and an electrostatic force directed from the intermediate transfer belt 20 toward the recording medium P acts on the toner image, so that the toner image on the intermediate transfer belt 20 is transferred onto the recording medium P. In this case, the second transfer bias is determined according to a resistance detected by resistance detection means for detecting the resistance of the second transfer portion and is constant-voltage-controlled. The intermediate transfer belt 20, the first transfer roller 5Y, and the second transfer roller 26 correspond to an example of the transfer device.

Then the recording medium P is fed to the fixing device 28 and inserted into a contact region in which the heating roller 30 rotated in the direction indicated by an arrow and the pressing belt 40 are in pressure contact with each other. In this case, the recording medium P is inserted such that the surface of the recording medium P on which the unfixed toner image has been formed and the surface of the heating roller 30 face each other. As the recording medium P passes through the contact region, heat and pressure are applied to the recording medium P, and the unfixed toner image is fixed to the recording medium P. The recording medium P after the fixation passes through the contact region, then separated from the heating roller 30, and discharged from the fixing device 28.

The fixation processing is performed as described above, and the image is permanently fixed to the recording medium P. The recording medium P with the color image fixed thereon is transported to an ejection portion, and a series of the color image formation operations is thereby completed.

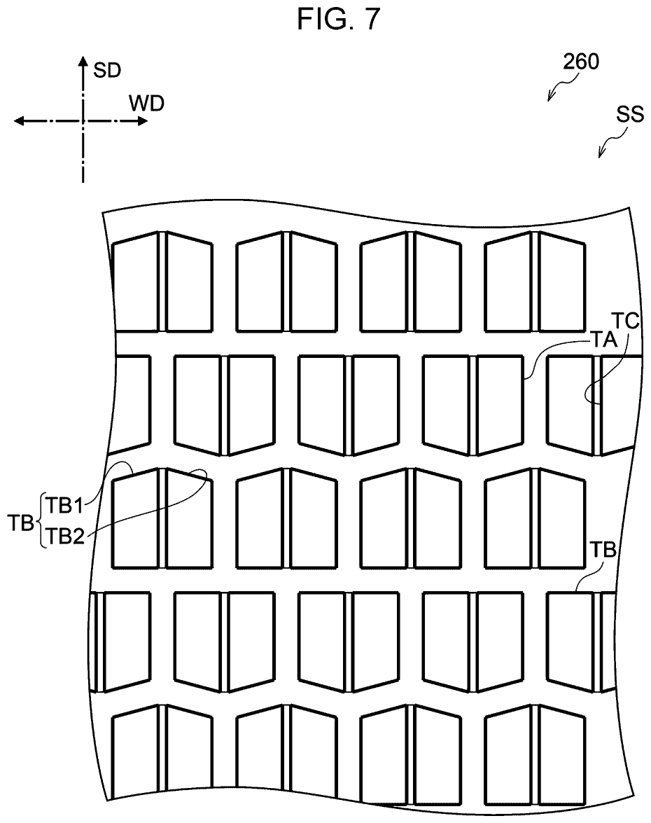

Next, a second exemplary embodiment of the present disclosure will be described with reference to FIG. 7. In the description of the second exemplary embodiment, the same symbols are used for the same structures as those in the first exemplary embodiment, and their detailed description will be omitted. FIG. 7 corresponds to FIG. 4 in the description of the first exemplary embodiment.

### (Sliding Sheet)

A sliding sheet 260 is an example of a sliding member according to the present exemplary embodiment. As shown in FIG. 7, in the sliding sheet 260 according to the present exemplary embodiment, a plurality of first grooves TA, a plurality of second grooves TB, and a plurality of third grooves TC are formed on the sliding surface SS. In the present exemplary embodiment, at least some of the plurality of second grooves each include first diagonal grooves TB1 extending in a direction inclined with respect to the sliding direction SD so as to connect, to each other, adjacent first grooves TA diagonally adjacent to each other in the width direction WD. The at least some of the plurality of second grooves each further include second diagonal grooves TB2 line-symmetric to the first diagonal grooves TB1 with respect to the sliding direction SD.

As shown in FIG. 7, the first diagonal grooves TB1 and the second diagonal grooves TB2 are formed so as to be arranged alternately in the width direction WD. In this case, as shown in FIG. 7, the first diagonal grooves TB1 and the second diagonal grooves TB2 form flow channels that are narrowed toward first grooves TA disposed on the downstream side in the sliding direction SD.

In the present exemplary embodiment, the first diagonal grooves TB1 and the second diagonal grooves TB2 are arranged in the sliding direction SD at positions aligned in the width direction WD, as shown in FIG. 7. In other words, in the present exemplary embodiment, the second grooves TB include first second grooves including first diagonal grooves TB1 and second diagonal grooves TB2 and second second grooves including no first diagonal grooves TB1 and no second diagonal grooves TB2, and the first second grooves and the second second grooves are arranged alternately in the sliding direction SD. In this case, the first grooves TA, the second grooves TB, and the first and second diagonal grooves TB1 and TB2 included in the second grooves TB form pentagonal grooves on the sliding surface SS, and each pentagonal groove has two right angles at adjacent corners.

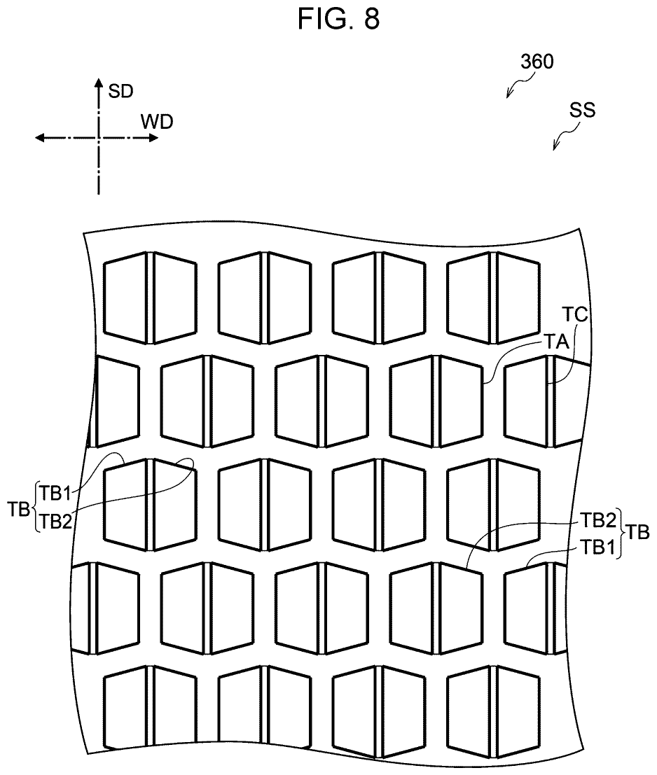

Next, a third exemplary embodiment of the present disclosure will be described with reference to FIG. 8. In the description of the third exemplary embodiment, the same symbols are used for the same structures as those in the first or second exemplary embodiment, and their detailed description will be omitted. FIG. 8 corresponds to FIG. 4 in the description of the first exemplary embodiment.

### (Sliding Sheet)

A sliding sheet 360 is an example of a sliding member according to the present exemplary embodiment. As shown in FIG. 8, in the sliding sheet 360 according to the present exemplary embodiment, a plurality of first grooves TA, a plurality of second grooves TB, and a plurality of third grooves TC are formed on the sliding surface SS. In the present exemplary embodiment also, each second groove TB includes first diagonal grooves TB1 and second diagonal grooves TB2.

As shown in FIG. 8, the first diagonal grooves TB1 and the second diagonal grooves TB2 are formed so as to be arranged alternately in the width direction WD. In this case, as shown in FIG. 8, the first diagonal grooves TB1 and the second diagonal grooves TB2 form flow channels that are narrowed toward first grooves TA formed on the downstream side in the sliding direction SD.

In the present exemplary embodiment, the first diagonal grooves TB1 and the second diagonal grooves TB2 are arranged in the sliding direction SD so as to be staggered from each other in the width direction WD, as shown in FIG. 8. In other words, in the present exemplary embodiment, the second grooves TB including the respective first and second diagonal grooves TB1 and TB2 are arranged in the sliding direction SD such that the first and second diagonal grooves TB1 and TB2 are staggered in the width direction WD. In other words, in the present exemplary embodiment, each second groove TB connected to first grooves TA includes first diagonal grooves TB 1 and second diagonal grooves TB2. In this case, the first grooves TA and the first and second diagonal grooves TB1 and TB2 included in the second grooves TB form hexagonal grooves on the sliding surface SS.

### Other Modifications

In the exemplary embodiments described above, the first grooves TA, the second grooves TB, and the third grooves TC are formed over the entire sliding surfaces SS of the sliding sheets 160, 260, and 360. However, the technique in the present disclosure is not limited thereto. It is only necessary that the above-described structure be used for at least part of the sliding surface SS. Specifically, sliding sheets 160, 260, and 360 in which the structure of the technique of the present disclosure is used for part of the sliding surface SS are within the technological scope of the present disclosure. The same applies to a fixing device 28 using one of the sliding sheets 160, 260, and 360 and to an image forming apparatus 100 using the fixing device 28.

In the description described above, all the first grooves TA have the same shape. However, the technique in the present disclosure is not limited thereto. The first grooves TA may have a plurality of different shapes within the technical idea of the present disclosure. The second grooves TB and the third grooves TC may also have a plurality of different shapes within the technical idea of the present disclosure.

### EXAMPLES

Examples will next be described. However, the present disclosure is not at all limited to these Examples. In the following description, “parts” and “%” are based on mass, unless otherwise specified.

### <Test Conditions>

A polyether ether ketone (PEEK) resin (Victrex 450G (manufactured by Victrex)) is heated to 380° C. and melted in a twin-screw extrusion melt kneader (twin-screw melt kneading extruder L/D60 (manufactured by PARKER CORPORATION)). 10 Parts by mass of unmodified thermosetting silicone resin particles (“KMP590” manufactured by Shin-Etsu Chemical Co., Ltd., average particle diameter=2 μm) are supplied to 100 parts by mass of the molten PEEK resin from a side portion of the kneader using a side feeder, and the mixture is melted and kneaded. The kneaded molten mixture is placed in a water bath to cool and solidify the mixture, and the resulting mixture is cut to a desired size to thereby obtain resin mixture pellets containing the silicone resin particles.

The obtained resin mixture pellets are fed to a single-screw extruder, and the molten resin mixture is extruded from a T die (melt discharge gap: 200 μm) heated to 380° C. into a sheet shape. The sheet is wound around a cooling roller at 190° C. to cool the sheet. The cooled sheet is caused to pass between a die roller heated to 250° C. and a heat-resistant silicone rubber roller at a pressure of 40 MPa to transfer the surface shape of the die roller to thereby obtain a sheet in which a plurality of grooves arranged in the width direction WD at intervals in the lengthwise direction of the sheet are formed in opposite end portions and a central portion with respect to the width direction WD of the sheet. The sheet with the projections and depressions is cut into a prescribed size.

A sliding sheet is obtained in the manner described above. The sliding sheet has the sliding surface SS on which the plurality of grooves arranged in the width direction WD at intervals in the sliding direction SD are formed in the opposite end portions and central portion, with respect to the width direction WD, of the sliding surface SS. The grooves have a V-shape when a cross section obtained by cutting the sliding sheet in the sliding direction SD and the thickness direction is observed and have dimensions shown in Table 1. Different die rollers having different surface shapes are used to obtain sliding sheets in Examples having different groove shapes.

The depth D1 and pitch PI of first grooves TA and the depth D2 of third grooves TC in Table 1 are as described above and shown in FIGS. 3, 4, and 5. The angle A, angle B, and depth D of second grooves TB in Table 1 are as described above and shown in FIGS. 3, 4, and 6. In the Examples and Comparative Examples shown in Table 1, the lengths of the first grooves TA are all 440 μm.

The inclination angle of second grooves TB in Table 1 is the angle of inclination of first and second diagonal grooves TB1 and TB2 with respect to the sliding direction SD. In other words, the first diagonal grooves TB1 and the second diagonal grooves TB2 are inclined by the inclination angle with respect to the sliding direction SD.

Specifically, Examples 1, 5, and 6 are Examples in which the sliding sheet 160 in the first exemplary embodiment of the present disclosure is used. Example 2 is an Example in which the sliding sheet 260 in the second exemplary embodiment of the present disclosure is used. Examples 3 and 4 are Examples in which the sliding sheet 360 in the third exemplary embodiment of the present disclosure is used.

In the Examples and Comparative Examples, the shapes of the plurality of first grooves TA formed in the sliding sheets are the same. Specifically, in the Examples and Comparative Examples, the shapes of the plurality of second grooves TB are the same, and the shapes of the plurality of third grooves TC are also the same.

### Evaluation Methods

One of the sliding sheets in the Examples is attached to a fixing device of an image forming apparatus “Revoria Press EC1100” manufactured by FUJIFILM Business Innovation Corp. This image forming apparatus is used to perform the following evaluation.

### (Initial Sliding Resistance)

The initial sliding resistance in Table 1 is measured based on the coefficient of friction between the sliding sheet and a sliding portion of a fixing member measured before a paper sheet is caused to pass through the fixing device (i.e., before the image formation is performed). The coefficient of friction is measured based on the current value of a motor driving a heating roller that is a driving roller of the fixing device. More specifically, a calibration curve for the relation between the current value of the motor and the coefficient of friction is drawn in advance, and the coefficient of friction is computed from the current value.

The initial sliding resistance is evaluated according to the following evaluation criteria with the target coefficient of friction set to 0.08.
A++: The coefficient of friction is less than 60% of the target coefficient of friction.
A+: The coefficient of friction is less than 70% of the target coefficient of friction.
A: The coefficient of friction is less than 80% of the target coefficient of friction.
B+: The coefficient of friction is 80% or more and 90% or less of the target coefficient of friction.
B: The coefficient of friction is more than 90% and 100% or less of the target coefficient of friction.
C: The coefficient of friction is more than 100% and 120% or less of the target coefficient of friction.
D: The coefficient of friction is more than 120% and 140% or less of the target coefficient of friction.
E: The coefficient of friction is more than 140% the target coefficient of friction.

### (Ability to Maintain Sliding Resistance)

The ability to maintain the sliding resistance in Table 1 is measured as follows. The image forming apparatus is used to perform image formation, and 1200000 paper sheets are caused to pass through the fixing device. Then the measurement is performed based on the coefficient of friction between the sliding sheet and the sliding portion of the fixing member. The method for measuring the coefficient of friction is the same as that for the evaluation of the “initial sliding resistance.”

The ability to maintain the sliding resistance is evaluated according to the following evaluation criteria.
A++: The coefficient of friction is 40% or less of the target coefficient of friction (=0.08).
A+: The coefficient of friction is 50% or less of the target coefficient of friction (=0.08).
A: The coefficient of friction is 60% or less of the target coefficient of friction (=0.08).
B+: The coefficient of friction is more than 60% and 70% or less of the target coefficient of friction (=0.08).
B: The coefficient of friction is more than 70% and 80% or less of the target coefficient of friction (=0.08).
C: The coefficient of friction is more than 80% and 100% or less of the target coefficient of friction (=0.08).
D: The coefficient of friction is more than 100% and 120% or less of the target coefficient of friction (=0.08).
E: The coefficient of friction is more than 120% of the target coefficient of friction (=0.08).

TABLE 1

| | | Shape of first grooves | | | | Shape of second grooves | | | |
|---|---|---|---|---|---|---|---|---|---|
| | | Cross | | | | Cross | | | |
| | | sectional | | Depth | Pitch | sectional | Angle | Angle | |
| | Groove | area | Width | D1 | P1 | area | A | B | Width |
| | type | μm² | μm | μm | μm | μm² | ° | ° | μm |
| Example 1 | Rectangle | 2500 | 83 | 30 | 440 | 2500 | 43 | 33 | 83 |
| Example 2 | Pentagon | 2500 | 83 | 30 | 440 | 2500 | 43 | 33 | 83 |
| Example 3 | Hexagon | 2500 | 83 | 30 | 440 | 2500 | 43 | 33 | 83 |
| Example 4 | Hexagon | 3333 | 83 | 40 | 440 | 2500 | 25 | 17 | 83 |
| Example 5 | Rectangle | 3333 | 83 | 40 | 440 | 2500 | 45 | 35 | 83 |
| Example 6 | Rectangle | 1667 | 83 | 20 | 440 | 2500 | 18 | 13 | 83 |
| Comparative | No third | 2500 | 83 | 30 | 440 | 2500 | 43 | 33 | 83 |
| Example 1 | grooves | | | | | | | | |
| Comparative | First | 2500 | 83 | 30 | 440 | 2500 | 43 | 33 | 83 |
| Example 2 | grooves | | | | | | | | |
| | and third | | | | | | | | |
| | grooves | | | | | | | | |
| | have the | | | | | | | | |
| | same | | | | | | | | |
| | shape | | | | | | | | |

| | | | Shape of third | | | | | |
|---|---|---|---|---|---|---|---|---|
| | | | grooves | | | | Evaluation | |
| | Shape of second grooves | | Cross | | | | | Ability to |
| | Depth | Inclination | sectional | | Depth | | Initial | maintain |
| | D | angle | area | Width | D2 | | sliding | sliding |
| | μm | ° | μm² | μm | μm | D2/D1 | resistance | resistance |
| Example 1 | 30 | — | 833 | 83 | 10 | 0.33 | A | A |
| Example 2 | 30 | 5 | 833 | 83 | 10 | 0.33 | A+ | A |
| Example 3 | 30 | 5 | 833 | 83 | 10 | 0.33 | A+ | A+ |
| Example 4 | 30 | 5 | 417 | 83 | 5 | 0.13 | A++ | A++ |
| Example 5 | 30 | — | 58 | 83 | 0.7 | 0.02 | B+ | B+ |
| Example 6 | 30 | — | 667 | 83 | 8 | 0.40 | C | C |
| Comparative | 30 | — | — | — | — | — | E | E |
| Example 1 | | | | | | | | |
| Comparative | 30 | — | 2500 | 83 | 30 | 1.00 | D | D |
| Example 2 | | | | | | | | |

As can be seen from the above results, the initial sliding resistance and the ability to maintain the sliding resistance of the sliding sheets in the Examples are better than those of the sliding sheets in the Comparative Examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))) A sliding member having a sliding surface on which a sliding object slides,
   wherein the sliding surface has formed thereon a plurality of first grooves, a plurality of second grooves, and a plurality of third grooves,
   wherein the first grooves extend in a sliding direction of the sliding object and are arranged in the sliding direction at intervals in a plurality of rows,
   wherein the plurality of rows are arranged in an orthogonal direction orthogonal to the sliding direction at intervals,
   wherein, in two adjacent rows of the plurality of rows that are adjacent to each other in the orthogonal direction, the first grooves in one of the two adjacent rows are staggered from the first grooves in the other one of the two adjacent rows in the sliding direction,
   wherein the second grooves extend in a direction different from the direction in which the first grooves extend,
   wherein the second grooves connect, to each other, adjacent ones of the plurality of first grooves that are adjacent to each other in the orthogonal direction and connect, to each other, adjacent ones of the plurality of first grooves that are diagonally adjacent to each other and displaced from each other in the sliding direction,
   wherein each of the third grooves extends in the sliding direction and connects corresponding two adjacent ones of the plurality of first grooves that are adjacent to each other in the sliding direction, and
   wherein at least part of each of the third grooves has a smaller cross-sectional area than each of the first grooves.
(((2))) The sliding member according to (((1))), wherein at least some of the plurality of second grooves each include first diagonal grooves extending in an extending direction inclined with respect to the sliding direction so as to connect, to each other, first adjacent ones of the plurality of first grooves that are diagonally adjacent to each other in the orthogonal direction and second diagonal grooves that extend in a direction line-symmetric to the extending direction of the first diagonal grooves with respect to the sliding direction so as to connect, to each other, second adjacent ones of the plurality of first grooves that are diagonally adjacent to each other in the orthogonal direction.
(((3))) The sliding member according to (((2))), wherein each of the plurality of first grooves is connected on both sides in the sliding direction to corresponding ones of the first and second diagonal grooves in the at least some of the plurality of second grooves.
(((4))) The sliding member according to any one of (((1))) to (((3))), wherein an entire part of each of the third grooves has a smaller cross sectional area than each of the first grooves.
(((5))) The sliding member according to (((4))), wherein the third grooves have a smaller depth than the first grooves.
(((6))) The sliding member according to (((5))), wherein D2/D1 is 0.02 or more and 0.35 or less, where D1 is the depth of the first grooves, and D2 is the depth of the third grooves.
(((7))) The sliding member according to (((6))), wherein D2/D1 is 0.07 or more and 0.20 or less.
(((8))) The sliding member according to any one of (((1))) to (((7))), wherein, when a cross section obtained by cutting one of the second grooves in a depth direction is observed, an angle A between the sliding direction and a wall surface of the one of the second grooves that is located on a downstream side in the sliding direction is 21° or more and 45° or less.
(((9))) The sliding member according to (((8))), wherein the angle A is 23° or more and 40° or less.
(((10))) The sliding member according to any one of (((1))) to (((9))), wherein, when a cross section obtained by cutting one of the second grooves in a depth direction is observed, an angle B between the sliding direction and a wall surface of the one of the second grooves that is located on an upstream side in the sliding direction is 10° or more and 35° or less.
(((11))) The sliding member according to (((10))), wherein the angle B is 15° or more and 30° or less.
(((12))) A fixing device including:
a first rotatable member;
a second rotatable member disposed in contact with the first rotatable member;
a pressing member that is disposed along an inner circumferential surface of the second rotatable member and presses the inner circumferential surface of the second rotatable member such that the second rotatable member is pressed against the first rotatable member; and
the sliding member according to any one of (((1))) to (((11))), the sliding member being interposed between the pressing member and the inner circumferential surface of the second rotatable member serving as the sliding object.
(((13))) An image forming apparatus including:
an image holding member;
a latent image forming device that forms a latent image on a surface of the image holding member;
a developing device that develops the latent image using a developer to form a toner image;
a transfer device that transfers the developed toner image onto a recording medium; and
the fixing device according to (((12))), the fixing device fixing the toner image to the recording medium.

What is claimed is:

1. A sliding member having a sliding surface on which a sliding object slides,
wherein the sliding surface has formed thereon a plurality of first grooves, a plurality of second grooves, and a plurality of third grooves,
wherein the first grooves extend in a sliding direction of the sliding object and are arranged in the sliding direction at intervals in a plurality of rows,
wherein the plurality of rows are arranged in an orthogonal direction orthogonal to the sliding direction at intervals,
wherein, in two adjacent rows of the plurality of rows that are adjacent to each other in the orthogonal direction, the first grooves in one of the two adjacent rows are staggered from the first grooves in the other one of the two adjacent rows in the sliding direction,
wherein the second grooves extend in a direction different from the direction in which the first grooves extend,
wherein the second grooves connect, to each other, adjacent ones of the plurality of first grooves that are adjacent to each other in the orthogonal direction and connect, to each other, adjacent ones of the plurality of first grooves that are diagonally adjacent to each other and displaced from each other in the sliding direction,
wherein each of the third grooves extends in the sliding direction and connects corresponding two adjacent ones of the plurality of first grooves that are adjacent to each other in the sliding direction, and
wherein at least part of each of the third grooves has a smaller cross-sectional area than each of the first grooves.

2. The sliding member according to claim 1, wherein at least some of the plurality of second grooves each include first diagonal grooves extending in an extending direction inclined with respect to the sliding direction so as to connect, to each other, first adjacent ones of the plurality of first grooves that are diagonally adjacent to each other in the orthogonal direction and second diagonal grooves that extend in a direction line-symmetric to the extending direction of the first diagonal grooves with respect to the sliding direction so as to connect, to each other, second adjacent ones of the plurality of first grooves that are diagonally adjacent to each other in the orthogonal direction.

3. The sliding member according to claim 2, wherein each of the plurality of first grooves is connected on both sides in the sliding direction to corresponding ones of the first and second diagonal grooves in the at least some of the plurality of second grooves.

4. The sliding member according to claim 1, wherein an entire part of each of the third grooves has a smaller cross sectional area than each of the first grooves.

5. The sliding member according to claim 4, wherein the third grooves have a smaller depth than the first grooves.

6. The sliding member according to claim 5, wherein D2/D1 is 0.02 or more and 0.35 or less, where D1 is the depth of the first grooves, and D2 is the depth of the third grooves.

7. The sliding member according to claim 6, wherein D2/D1 is 0.07 or more and 0.20 or less.

8. The sliding member according to claim 1, wherein, when a cross section obtained by cutting one of the second grooves in a depth direction is observed, an angle A between the sliding direction and a wall surface of the one of the second grooves that is located on a downstream side in the sliding direction is 21° or more and 45° or less.

9. The sliding member according to claim 8, wherein the angle A is 23° or more and 40° or less.

10. The sliding member according to claim 1, wherein, when a cross section obtained by cutting one of the second grooves in a depth direction is observed, an angle B between the sliding direction and a wall surface of the one of the second grooves that is located on an upstream side in the sliding direction is 10° or more and 35° or less.

11. The sliding member according to claim 10, wherein the angle B is 15° or more and 30° or less.

12. A fixing device comprising:
a first rotatable member;
a second rotatable member disposed in contact with the first rotatable member;
a pressing member that is disposed along an inner circumferential surface of the second rotatable member and presses the inner circumferential surface of the second rotatable member such that the second rotatable member is pressed against the first rotatable member; and
the sliding member according to claim 1, the sliding member being interposed between the pressing member and the inner circumferential surface of the second rotatable member serving as the sliding object.

13. A fixing device comprising:
a first rotatable member;
a second rotatable member disposed in contact with the first rotatable member;
a pressing member that is disposed along an inner circumferential surface of the second rotatable member and presses the inner circumferential surface of the second rotatable member such that the second rotatable member is pressed against the first rotatable member; and
the sliding member according to claim 2, the sliding member being interposed between the pressing member and the inner circumferential surface of the second rotatable member serving as the sliding object.

14. A fixing device comprising:
a first rotatable member;
a second rotatable member disposed in contact with the first rotatable member;
a pressing member that is disposed along an inner circumferential surface of the second rotatable member and presses the inner circumferential surface of the second rotatable member such that the second rotatable member is pressed against the first rotatable member; and
the sliding member according to claim 3, the sliding member being interposed between the pressing member and the inner circumferential surface of the second rotatable member serving as the sliding object.

15. A fixing device comprising:
a first rotatable member;
a second rotatable member disposed in contact with the first rotatable member;
a pressing member that is disposed along an inner circumferential surface of the second rotatable member and presses the inner circumferential surface of the second rotatable member such that the second rotatable member is pressed against the first rotatable member; and
the sliding member according to claim 4, the sliding member being interposed between the pressing member and the inner circumferential surface of the second rotatable member serving as the sliding object.

16. A fixing device comprising:
a first rotatable member;
a second rotatable member disposed in contact with the first rotatable member;
a pressing member that is disposed along an inner circumferential surface of the second rotatable member and presses the inner circumferential surface of the second rotatable member such that the second rotatable member is pressed against the first rotatable member; and
the sliding member according to claim 5, the sliding member being interposed between the pressing member and the inner circumferential surface of the second rotatable member serving as the sliding object.

17. A fixing device comprising:
a first rotatable member;
a second rotatable member disposed in contact with the first rotatable member;
a pressing member that is disposed along an inner circumferential surface of the second rotatable member and presses the inner circumferential surface of the second rotatable member such that the second rotatable member is pressed against the first rotatable member; and
the sliding member according to claim 6, the sliding member being interposed between the pressing member and the inner circumferential surface of the second rotatable member serving as the sliding object.

18. A fixing device comprising:
a first rotatable member;
a second rotatable member disposed in contact with the first rotatable member;
a pressing member that is disposed along an inner circumferential surface of the second rotatable member and presses the inner circumferential surface of the second rotatable member such that the second rotatable member is pressed against the first rotatable member; and
the sliding member according to claim 7, the sliding member being interposed between the pressing member and the inner circumferential surface of the second rotatable member serving as the sliding object.

19. A fixing device comprising:
a first rotatable member;
a second rotatable member disposed in contact with the first rotatable member;
a pressing member that is disposed along an inner circumferential surface of the second rotatable member and presses the inner circumferential surface of the second rotatable member such that the second rotatable member is pressed against the first rotatable member; and
the sliding member according to claim 8, the sliding member being interposed between the pressing member and the inner circumferential surface of the second rotatable member serving as the sliding object.

20. An image forming apparatus comprising:
an image holding member;
a latent image forming device that forms a latent image on a surface of the image holding member;
a developing device that develops the latent image using a developer to form a toner image;
a transfer device that transfers the developed toner image onto a recording medium; and
the fixing device according to claim 12, the fixing device fixing the toner image to the recording medium.
